(19) United States
(12) Patent Application Publication
(10) Pub. No.: US 2007/0118820 A1
(43) Pub. Date: May 24, 2007

(54) Equipment control apparatus, remote controller, equipment, equipment control method, and equipment control program product

(75) Inventor: Kohichi Hatakeyama, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/545,542

(22) Filed: Oct. 11, 2006

(30) Foreign Application Priority Data
Oct. 12, 2005 (JP) 2005-297876

(51) Int. Cl. G06F 3/00; G06K 9/00

(52) U.S. Cl. 715/863; 382/181; 382/165

(57) ABSTRACT

An equipment control apparatus readily made smaller in size and less likely to malfunction is configured as follows. The equipment control apparatus includes a video camera, a CPU, and a terminal. The video camera picks up an image. The CPU determines whether a color of a pixel forming the image picked up by the video camera represents a color of skin of a human body, counts the specific number indicating the number of pixels of which color represents the color of skin of the human body for an area representing at least a part of the image, and determines whether the specific number exceeds a threshold value. A memory stores the specific number in association with the area. The terminal outputs a control signal of a type corresponding to the area, if the specific number exceeds the threshold value.

This nonprovisional application is based on Japanese Patent Application No. 2005-297876 filed with the Japan Patent Office on Oct. 12, 2005, the entire contents of which are hereby incorporated by reference.

### FIELD OF THE INVENTION

The present invention relates to an equipment control apparatus, a remote controller, equipment, an equipment control method, and an equipment control program product, and particularly to an equipment control apparatus controlling every equipment in a non-contact manner by converting data, a remote controller, equipment, an equipment control method, and an equipment control program product.

### DESCRIPTION OF THE BACKGROUND ART

Japanese Patent Laying-Open No. 06-153017 discloses a remote control apparatus including a monitor, an infrared camera detecting an image of a human body, and a CPU (Central Processing Unit) for controlling the display of the image of the human body detected by the infrared camera and superimposed control item areas for controlled equipment on a monitor screen, and when the image of the human body overlaps with the control item by a prescribed amount or more in the display screen, outputting a control instruction as to the overlapped control item to the controlled equipment. FIG. 10 illustrates an exemplary image of the human body displayed on the monitor of the remote control apparatus according to Japanese Patent Laying-Open No. 06-153017. FIG. 11 is a diagram illustrating a configuration of the remote control apparatus according to Japanese Patent Laying-Open No. 06-153017. When the remote control apparatus according to Japanese Patent Laying-Open No. 06-153017 is used, a user controls the controlled equipment by moving his/her own arms and legs while the user views the monitor on which his/her own body is displayed.

According to the invention disclosed in Japanese Patent Laying-Open No. 06-153017, as remote control is permitted while the human body is displayed on the monitor, a remote control device kept on hand is not necessary and the equipment can remotely be controlled from the same place. Examples of remotely controlled equipment include a television, an air conditioner, a personal computer, a video game machine, a portable phone, and the like.

Japanese Patent Laying-Open No. 2001-307107 discloses an image processing apparatus including a video camera which picks up an image of an object making gestures or hand gestures, a gesture recognition unit identifying the image picked up by the video camera, a region division unit dividing the image identified by the gesture recognition unit into prescribed regions, a motion detection unit detecting a direction of motion within the region obtained as a result of division by the region division unit, a gravity center calculation unit calculating the gravity center within the region based on a result of detection by the motion detection unit, a region evaluation unit calculating an evaluation value within the region and selecting a region having a smallest evaluation value based on the calculation result, a holding operation recognition state machine recognizing a holding operation by the object within the region selected by the region evaluation unit, and a gravity center trace recognition unit recognizing gesture of the object based on the trace of the gravity center within the region selected by the region evaluation unit.

According to the invention disclosed in Japanese Patent Laying-Open No. 2001-307107, as gestures or hand gestures can be recognized with high accuracy, interface between a person and a computer can be provided through gestures.

The invention disclosed in Japanese Patent Laying-Open No. 06-153017, however, suffers difficulty in achieving a smaller size of the remote control apparatus. As can clearly be seen from FIG. 11, the invention disclosed in Japanese Patent Laying-Open No. 06-153017 requires a monitor even for controlled equipment that originally does not require the monitor, such as an air conditioner. This is because the user has his/her own body displayed on the monitor. Presence of the monitor impedes reduction in size of the remote control apparatus, which makes it difficult to make smaller the remote control apparatus. In addition, according to the invention disclosed in Japanese Patent Laying-Open No. 06-153017, if the user makes a movement irrelevant to manipulation, malfunction is likely. If the whole body of the user is displayed on the monitor, tendency to malfunction is particularly noticeable.

The invention disclosed in Japanese Patent Laying-Open No. 2001-307107 also suffers a disadvantage that malfunction is likely, because the video camera is distant from the human body.

### SUMMARY OF THE INVENTION

The present invention was made to solve the above-described problems. An object of the present invention is to provide an equipment control apparatus readily made smaller in size and less likely to malfunction, a remote controller, equipment, an equipment control method, and an equipment control program product.

In order to achieve the object above, according to one aspect of the present invention, an equipment control apparatus is an equipment control apparatus for controlling equipment. The equipment control apparatus includes an image pick-up unit picking up an image, a storage unit, a processor, and an output unit. The storage unit stores image data and a program. The image data represents the image picked up by the image pick-up unit. The processor, upon receiving an instruction from the program, counts the number of pixels representing a color of skin of a human body among pixels in a part of the image, to output the counted number as a specific number based on the image data, and generates at least one control signal for controlling the equipment if the number exceeds a specific number threshold value. The output unit outputs the control signal.

In addition, desirably, a plurality of areas of the image correspond to different control signals respectively, and the processor described above counts the number of pixels representing the color of skin in each of the areas, and selectively generates one of the control signals corresponding to the area where the counted number exceeds a corresponding specific number threshold value.

Alternatively, desirably, the processor described above generates the control signal of a type corresponding to each of the areas of which specific number exceeds the specific number threshold value.

Alternatively, desirably, the processor described above counts the specific number for each of the plurality of areas obtained by dividing the image into two.

Alternatively, desirably, the processor described above counts the specific number for each of the plurality of areas adjacent to each other, obtained by dividing the image into four.

In addition, desirably, the storage unit described above stores the specific number in addition to the image data and the program. Moreover, desirably, the processor, upon receiving the instruction from the program, further determines whether excess number exceeds an excess number threshold value. The excess number indicates the number of times that the specific number exceeds the specific number threshold value. The excess number threshold value represents a threshold value for the excess number. Moreover, desirably, the processor generates the control signal if the excess number exceeds the excess number threshold value and if the specific number exceeds the specific number threshold value.

In addition, desirably, the storage unit described above stores the specific number in addition to the image data and the program. Moreover, desirably, the processor, upon receiving the instruction from the program, further determines whether excess number is equal to or smaller than an excess number threshold value. The excess number indicates the number of times that the specific number exceeds the specific number threshold value. The excess number threshold value represents a threshold value for the excess number. Moreover, desirably, the processor generates the control signal if the excess number is equal to or smaller than the excess number threshold value and if the specific number exceeds the specific number threshold value.

In addition, desirably, the storage unit described above stores the specific number in addition to the image data and the program. Moreover, desirably, the processor, upon receiving the instruction from the program, further determines whether excess number is within a range defined by two threshold values for the excess number. The excess number indicates the number of times that the specific number exceeds the specific number threshold value. Further, desirably, the processor generates the control signal if the excess number is within the range defined by the two threshold values and if the specific number exceeds the specific number threshold value.

In addition, desirably, the image pick-up unit described above includes an image pick-up unit implemented as a color camera.

In addition, desirably, the image pick-up unit described above includes an image pick-up unit using a lens different from a wide-angle lens.

In addition, desirably, the image pick-up unit described above includes an image pick-up unit picking up an infrared image.

In addition, desirably, the processor described above counts the specific number for a plurality of areas. Moreover, desirably, the storage unit stores, in addition to the image data and the program, the specific number for each of the plurality of areas. Moreover, if a largest specific number out of the specific numbers stored in the storage unit exceeds the specific number threshold value, the processor desirably generates the control signal of a type corresponding to the area having the largest specific number.

Alternatively, desirably, the processor described above counts the specific number for a plurality of areas. Moreover, desirably, the storage unit stores, in addition to the image data and the program, the specific number for each of the plurality of areas in association with a group of areas. Moreover, if at least one of largest specific numbers in each group of areas stored in the storage unit exceeds the specific number threshold value, the processor desirably generates the control signal of a type corresponding to the area of which largest specific number exceeds the specific number threshold value.

In addition, desirably, the image data stored in the storage unit described above includes image data of a plurality of images picked up by the image pick-up unit, different in a time point of image pick-up. Moreover, desirably, the processor, upon receiving the instruction from the program, further calculates a value representing difference in color of the pixels at corresponding positions in the plurality of images. Moreover, the processor desirably determines whether the value representing difference in color exceeds a threshold value for the value representing difference in color. Moreover, desirably, the storage unit stores, in addition to the image data and the program, a value corresponding to whether the value representing difference in color exceeds the threshold value for the value representing difference in color. Moreover, desirably, the specific number indicates the number of pixels corresponding to the value representing difference in color exceeding the threshold value for the value representing difference in color, and representing the color of skin of the human body among the pixels forming a most recent image among the plurality of images.

In addition, desirably, the image data stored in the storage unit described above includes image data of a plurality of images picked up by the image pick-up unit, different in a time point of image pick-up. Moreover, desirably, the processor, upon receiving the instruction from the program, further calculates a value representing difference in color of the pixels at corresponding positions in the plurality of images. Moreover, the processor desirably further determines whether the value representing difference in color is equal to or smaller than a threshold value for the value representing difference in color. Moreover, desirably, the storage unit stores, in addition to the image data and the program, a value corresponding to whether the value representing difference in color is equal to or smaller than the threshold value for the value representing difference in color. Moreover, desirably, the specific number indicates the number of pixels corresponding to the value representing difference in color equal to or smaller than the threshold value for the value representing difference in color, and representing the color of skin of the human body among the pixels forming a most recent image among the plurality of images.

In addition, desirably, the equipment control apparatus described above further includes a housing.

According to another aspect of the present invention, a remote controller is a remote controller for controlling equipment. The remote controller includes an image pick-up unit picking up an image, a storage unit, a processor, and a transmission device. The storage unit stores image data, a program and information for controlling the equipment. The image data represents an image picked up by the image pick-up unit. The processor executes the following processing, upon receiving an instruction from the program. The processing includes the processing for counting the specific number and the processing for generating a control signal. The processing for counting the specific number is the processing for counting the specific number for an area based on the image data. The area represents at least a part of the image. The specific number indicates the number of pixels representing a color of skin of a human body among pixels forming the image. The processing for generating a control signal is the processing for generating a control signal for controlling the equipment based on the information for controlling the equipment if the specific number exceeds a specific number threshold value. The specific number threshold value is a threshold value for the specific number. The transmission device transmits the control signal.

According to another aspect of the present invention, equipment includes an image pick-up unit picking up an image, a storage unit, a processor, and a device operating in response to a control signal. The storage unit stores image data and a program. The image data represents an image picked up by the image pick-up unit. The processor executes the following processing, upon receiving an instruction from the program. The processing includes the processing for counting the specific number and the processing for generating a control signal. The processing for counting the specific number is the processing for counting the specific number for an area based on the image data. The area represents at least a part of the image. The specific number indicates the number of pixels representing a color of skin of a human body among pixels forming the image. The processing for generating a control signal is the processing for generating a control signal if the specific number exceeds a specific number threshold value. The specific number threshold value represents a threshold value for the specific number.

According to another aspect of the present invention, an equipment control method is an equipment control method for controlling equipment. The equipment control method includes image pick-up step, the step of determining whether a color is the color of skin of a human body, the step of counting the specific number, and the step of outputting a control signal. The image pick-up step is the step of picking up an image. The step of determining whether a color is the color of skin of a human body is the step of determining whether a color of a pixel forming the image picked up in the image pick-up step is a color of skin of a human body. The step of counting the specific number is the step of counting the specific number for an area. The area represents at least a part of the image. The specific number indicates the number of pixels representing a color of skin of a human body among pixels forming the image. The step of outputting a control signal is the step of outputting a control signal for controlling the equipment if the specific number exceeds a specific number threshold value. The specific number threshold value represents a threshold value for the specific number.

According to another aspect of the present invention, an equipment control program product is an equipment control program product for controlling equipment. The equipment control program product causes a computer to execute the steps of controlling an image pick-up unit, determining whether a color is the color of skin of a human body, counting the specific number, and outputting a control signal. The step of controlling an image pick-up unit is the step of controlling an image pick-up unit so as to pick up an image. The step of determining whether a color is the color of skin of a human body is the step of determining whether a color of a pixel forming the image picked up in the controlling step is a color of skin of a human body. The step of counting the specific number is the step of counting the specific number for an area. The area represents at least a part of the image. The specific number indicates the number of pixels representing a color of skin of a human body among pixels forming the image. The step of outputting a control signal is the step of outputting a control signal for controlling the equipment if the specific number exceeds a specific number threshold value. The specific number threshold value represents a threshold value for the specific number.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual diagram illustrating a configuration of an equipment control apparatus and a method of using the same according to a first embodiment of the present invention.

FIG. 2 is a control block diagram of the equipment control apparatus according to the first embodiment of the present invention.

FIG. 3 is a flowchart illustrating a control procedure for control signal output processing according to the first embodiment of the present invention.

FIG. 4 illustrates arrangement of divisional areas according to the first embodiment of the present invention.

FIG. 5 illustrates appearance of a remote controller according to a variation of the first embodiment of the present invention.

FIG. 6 is a conceptual diagram illustrating a method of using the remote controller according to the variation of the first embodiment of the present invention.

FIG. 7 is a flowchart illustrating a control procedure for control signal output processing according to a second embodiment of the present invention.

FIG. 8 is a flowchart illustrating a control procedure for control signal output processing according to a third embodiment of the present invention.

FIG. 9 is a flowchart illustrating a control procedure for control signal output processing according to a fourth embodiment of the present invention.

FIG. 10 illustrates an exemplary image of a human body displayed on a monitor of a remote control apparatus according to a conventional example.

FIG. 11 illustrates a configuration of the remote control apparatus according to the conventional example.

### DESCRIPTION OF THE PREFERRED EMBODIMENTS

An embodiment of the present invention will be described hereinafter with reference to the drawings. In the description, the same elements have the same reference characters allotted. Their label and function are also identical. Therefore, detailed description thereof will not be repeated.

### First Embodiment

An equipment control apparatus according to a first embodiment of the present invention will be described hereinafter.

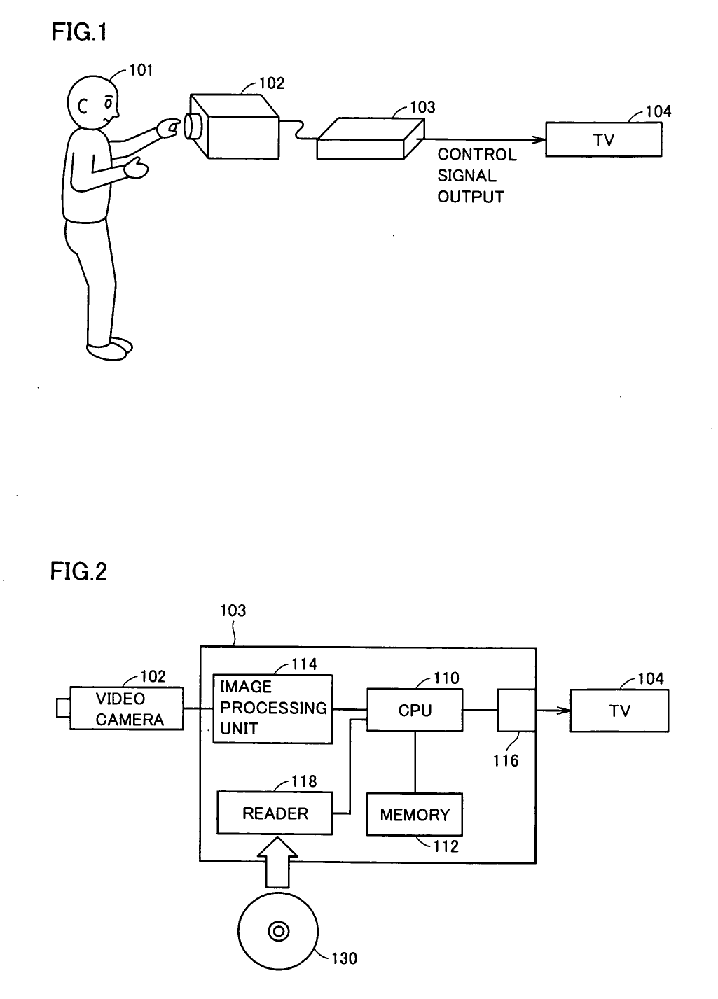

FIG. 1 is a conceptual diagram illustrating a configuration of the equipment control apparatus and a method of using the same according to the present embodiment.

FIG. 2 is a control block diagram of the equipment control apparatus according to the present embodiment. Referring to FIGS. 1 and 2, the equipment control apparatus includes a video camera 102 and a main apparatus 103. Video camera 102 is an apparatus that picks up an image of a hand or the like of a user 101. In the present embodiment, video camera 102 is implemented as a color camera equipped with a unit for image pick-up and employing a lens different from a wide-angle lens. Whether a lens may be mounted on video camera 102 or not is determined based on whether the entire image pick-up area is covered by a hand or the like when user 101 holds the hand or the like at a position several centimeters forward of the lens. In the present embodiment, a lens having an angle of view of 60° is used as the “lens different from a wide-angle lens.” Main apparatus 103 is an apparatus processing the image picked up by video camera 102. A signal output after main apparatus 103 processes the image is output to a television receiver 104. In the present embodiment, each of video camera 102 and main apparatus 103 is covered with a housing. These housings allow the equipment control apparatus according to the present embodiment to be embedded in a wall of a building. More specifically, these housings are housings having a heat insulating material along an inner side of a steel plate.

Main apparatus 103 includes a CPU 110, a memory 112, an image processing unit 114, a terminal 116, and a reader 118. CPU 110 is a device performing various operations based on a signal processed by image processing unit 114. CPU 110 thus serves as a device attaining various functions. CPU 110 also serves as a device generating a control signal. CPU 110 includes a buffer storing image data of the image picked up by video camera 102, a counter counting the number, and a timer measuring elapsed time. Memory 112 is a device storing information. In the present embodiment, memory 112 includes a plurality of areas. Each of the plurality of areas in memory 112 stores different information. Image processing unit 114 is a device processing the image picked up by video camera 102. As a result of processing by image processing unit 114, a signal output from video camera 102 is converted to a signal that CPU 110 can make use of Terminal 116 is a terminal outputting the control signal generated by CPU 110. Reader 118 reads a program for implementing the equipment control apparatus according to the present embodiment from a recording medium. In the present embodiment, the recording medium from which reader 118 reads the program is implemented by a CD-ROM (Compact Disk Read Only Memory) 130.

The equipment control apparatus according to the present embodiment is implemented by computer hardware including the apparatus for image pick-up and software executed by CPU 110. The “computer hardware including the apparatus for image pick-up” includes computer hardware on which video camera 102 is mounted, in addition to computer hardware to which video camera 102 is connected. Examples of the computer hardware to which video camera 102 is connected include a PDA (Personal Digital Assistant) on which a camera is mounted, and the like. In general, such software is distributed with being stored in a recording medium such as CD-ROM 130, read from the recording medium by reader 118 or the like, and once stored in memory 112. In addition, the software is executed by CPU 110 described above. The computer hardware itself described above is common. Therefore, the most essential part of the present invention resides in the software recorded in a recording medium such as CD-ROM 130. Here, as an operation of the computer itself is well known, detailed description thereof will not be repeated.

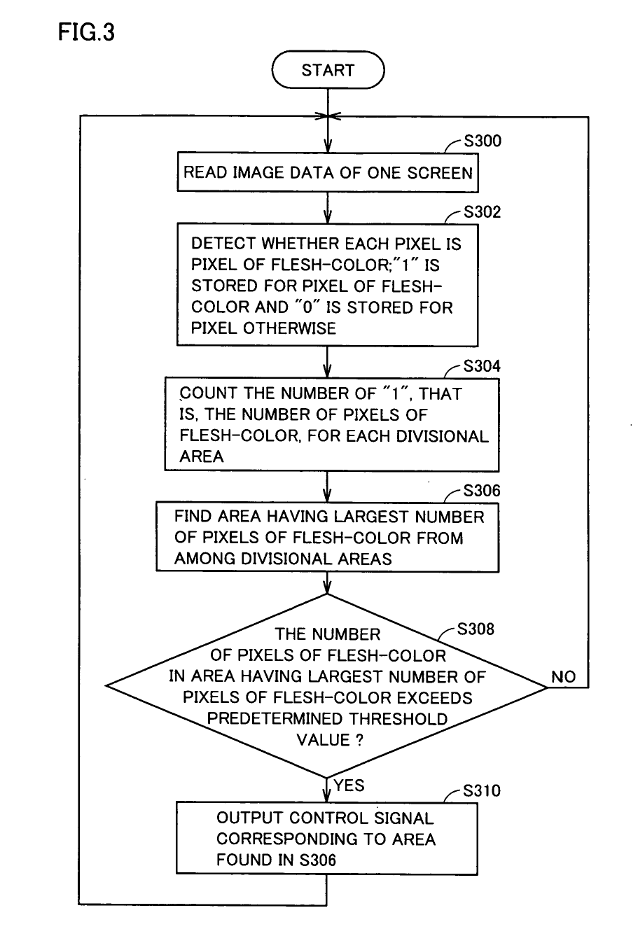

Referring to FIG. 3, the program executed in the equipment control apparatus according to the present embodiment carries out the following control for output of a control signal.

In step 300 (hereinafter, step is abbreviated as S), video camera 102 picks up an image. Video camera 102 outputs image data of the picked up image as a signal. Image processing unit 114 reads the image data of the image picked up by video camera 102. The read image data is image data of one screen. Image processing unit 114 converts the read signal to a signal that CPU 110 can make use of.

In S302, CPU 110 determines whether each pixel is a pixel of flesh-color or not. Here, “each pixel” refers to a pixel forming the image picked up by video camera 102. The “pixel of flesh-color” refers to a pixel having a color of skin of the human body. Whether the color of the pixel is the color of skin of the human body is determined based on whether a value representing the color of the pixel is within a range determined in advance by a manufacturer or a user of the equipment control apparatus of the present embodiment. In the present embodiment, the range is defined by an empirical value determined in accordance with an illumination condition, an ethnic group to which the user belongs, or the like. If data of the color of each pixel is the data that can be obtained based on YCrCb representation system, CPU 110 can determine, in a stable manner, whether or not data of the color of each pixel represents the color of the skin, regardless of luminance. When whether or not each pixel is the pixel of flesh-color is determined, CPU 110 causes memory 112 to store a value. The area of memory 112 storing the value is the area for storing the pixel of flesh-color. The value stored in memory 112 is a value corresponding to whether the pixel is the pixel of flesh-color or not. In the present embodiment, it is assumed that the value “1” is stored in memory 112 for the pixel of flesh-color and “0” is stored for the pixel otherwise.

In S304, CPU 110 refers to the value stored in memory 112 in S302. When the value is referred to, CPU 110 counts the specific number. Here, the “specific number” refers to the number of pixels that are pixels of flesh-color. In the present embodiment, CPU 110 counts the specific number for each divisional area. As the specific number is counted for each divisional area, CPU 110 counts the specific number for an area representing at least a part of the image. When the specific number is counted, memory 112 stores the specific number in association with the divisional area. The area of memory 112 storing the specific number is the area for storing the specific number.

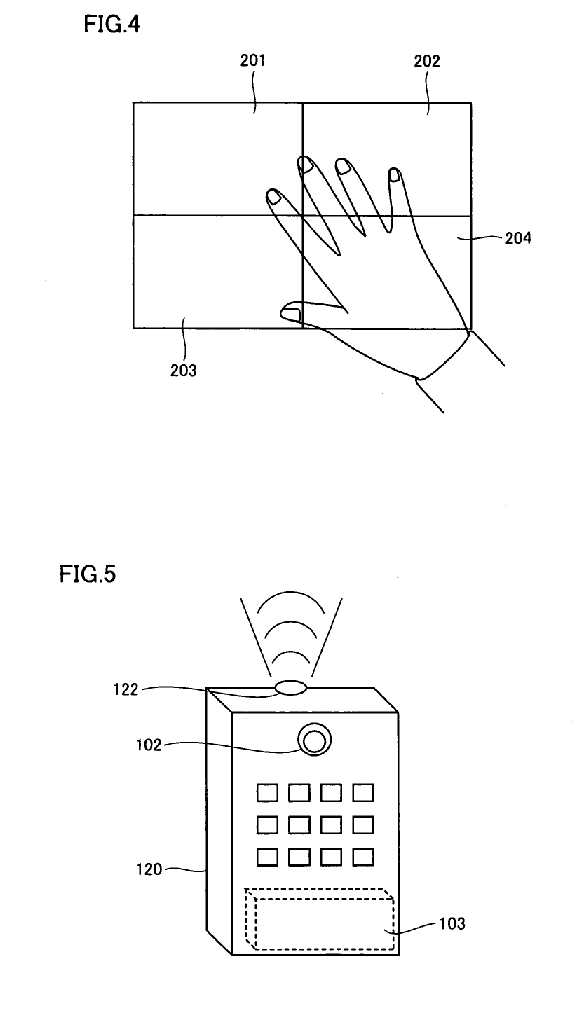

The divisional area will be described with reference to FIG. 4. FIG. 4 illustrates arrangement of the divisional areas according to the present embodiment. In the present embodiment, the divisional areas include a first divisional area 201, a second divisional area 202, a third divisional area 203, and a fourth divisional area 204. As can clearly be seen from FIG. 4, in the present embodiment, each of first to fourth divisional areas 201 to 204 represents a part of the image. In addition, first to fourth divisional areas 201 to 204 according to the present embodiment are a plurality of areas adjacent to each other, obtained by dividing the image into four. CPU 110 thus counts the specific number for each of the plurality of areas adjacent to each other, obtained by dividing the image into four.

In S306, CPU 110 selects an area having the largest specific number from among the divisional areas, based on the specific number stored in memory 112.

In S308, CPU 110 determines whether the specific number of the area selected by the CPU itself exceeds a predetermined threshold value. If it is determined that the specific number exceeds the predetermined threshold value (YES in S308), the process proceeds to S310. Otherwise (NO in S308), the process proceeds to S300. In S310, terminal 116 outputs a control signal of a type corresponding to the divisional area selected in S306. CPU 110 generates the control signal based on prescribed information for controlling the equipment. The “prescribed information for controlling the equipment” has been stored in memory 112.

An operation of the equipment control apparatus based on the configuration and the flowchart as above will now be described.

User 101 puts out his/her hand toward video camera 102. Video camera 102 picks up the image of the hand of user 101. Video camera 102 outputs the picked-up image to image processing unit 114. Image processing unit 114 reads the image data of the image picked up by video camera 102 (S300). When the image data is read, CPU 110 determines whether each pixel is the pixel of flesh-color or not. When determination as to whether or not the pixel is the pixel of flesh-color is made, CPU 110 causes memory 112 to store the value in accordance with whether the pixel is the pixel of flesh-color (S302).

When the value is stored, CPU 110 counts the specific number for each divisional area (S304). In FIG. 4, the hand of user 101 overlaps most with fourth divisional area 204. The hand of user 101 slightly overlaps also with first to third divisional areas 201 to 203.

When the specific number is counted, CPU 110 selects the divisional area having the largest specific number (S306). As is clear from the description above and FIG. 4, fourth divisional area 204 has the largest specific number. CPU 110 selects fourth divisional area 204 as the area having the largest specific number.

When the area is selected, CPU 110 determines whether the specific number of fourth divisional area 204 exceeds a predetermined threshold value TH (S308). Here, if it is assumed that the specific number of fourth divisional area 204 exceeds threshold value TH (YES in S308), terminal 116 outputs the control signal of a type corresponding to fourth divisional area 204 (S310). In the present embodiment, it is assumed that the control signal corresponding to fourth divisional area 204 is the signal for turning up the volume of television receiver 104. The volume of television receiver 104 is thus turned up.

As described above, the equipment control apparatus according to the present embodiment outputs the control signal as a result of the user's movement of holding his/her hand over the video camera. When a quarter of the image pick-up region of the video camera is covered, the video camera outputs the control signal corresponding to the covered region. Accordingly, the equipment control apparatus according to the present embodiment does not respond unless the user puts out his/her hand or the like immediately in front of the video camera. Malfunction does not occur unless the hand or the like is put out immediately in front of the video camera. Malfunction does not occur simply by slightly covering the video camera. The equipment control apparatus according to the present embodiment can output the control signal without checking whether the hand covers the divisional area on a monitor or the like. This is because the equipment control apparatus according to the present embodiment does not respond or malfunction unless the hand or the like is put out immediately in front of the video camera and the image pick-up area is sufficiently covered. The reason why the equipment control apparatus does not respond or malfunction is that the image pick-up areas are implemented by the plurality of areas adjacent to each other, obtained by dividing the image. Consequently, as the monitor is not necessary, the equipment control apparatus readily made smaller in size and less likely to malfunction can be provided.

In addition, the equipment control apparatus according to the present embodiment can accurately determine whether the color of the pixel is the color of skin of a human, by using the color camera.

In addition, the video camera of the equipment control apparatus according to the present embodiment employs the lens different from the wide-angle lens. As the lens different from the wide-angle lens is employed, the user can readily cover an arbitrary area of the image by holding his/her hand or the like in front of the lens. As an arbitrary area of the image is readily covered, occurrence of malfunction can be suppressed. Malfunction can thus be less likely than in an example where the wide-angle lens is used. When the wide-angle lens is used, it is difficult to cover an arbitrary area of the image even if the hand or the like is held in front of the lens.

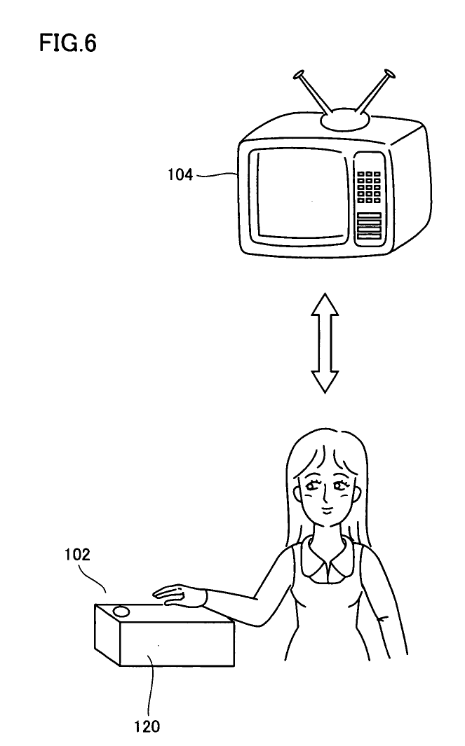

Note that, as a variation, the equipment control apparatus according to the present embodiment may be implemented as equipment. Examples of such equipment include a remote controller, a television receiver, a computer, a car navigation system, a pinball-type game machine, a portable phone, or a fan. FIG. 5 illustrates appearance of the equipment control apparatus implemented as a remote controller 120. Recently, a camera has been incorporated in a portable phone, and a camera unit has been reduced in size. The equipment control apparatus according to the present embodiment can be implemented sufficiently as a small apparatus such as a remote controller. The devices other than terminal 116 shown in FIG. 2 are included in remote controller 120. Remote controller 120 includes a transmission device 122 instead of terminal 116. Transmission device 122 is a device transmitting a control signal of a type corresponding to an area, using infrared ray or through a wire or the like, if the specific number exceeds a first threshold value. When remote controller 120 is manipulated in FIG. 5, user 101 holds his/her hand in front of video camera 102 provided on a surface of remote controller 120 and moves the hand. FIG. 6 illustrates a method of using remote controller 120. A person, for example, an elderly person who has difficulty in pressing a small button, can transmit the control signal solely by moving his/her hand around remote controller 120. Here, transmission device 122 may be a device connected to terminal 116. If transmission device 122 is connected to terminal 116, transmission device 122 is implemented as a device that operates in response to a control signal output from terminal 116.

In addition, as a variation, the divisional area for which the specific number is counted in S304 or the like may be an area different from those shown in FIG. 4. For example, first divisional area 201 and second divisional area 202 may serve as one area. In this case, third divisional area 203 and fourth divisional area 204 may serve as one area. Instead of first divisional area 201 and second divisional area 202 forming one area, first divisional area 201 and third divisional area 203 may serve as one area. In this case, second divisional area 202 and fourth divisional area 204 may serve as one area. The divisional areas are thus implemented as a plurality of areas adjacent to each other, obtained by dividing the image into two. If the divisional areas are implemented as such, CPU 110 counts the specific number for each of the plurality of areas adjacent to each other, obtained by dividing the image into two. The image pick-up area covered by user 101 in order to output the control signal is thus greater than in the case of division of the image into four. As the image pick-up area is greater, malfunction is less likely and manipulation is facilitated. Consequently, as compared with the case in which the control signal is output by covering the area obtained by dividing the image into four, malfunction is less likely and manipulation can be facilitated.

In addition, as a variation, the divisional area for which the specific number is counted in S304 or the like may be an area obtained by diagonally dividing the image. In the case that the divisional area is implemented as such as well, CPU 110 counts the specific number for each of the plurality of areas adjacent to each other, obtained by dividing the image into two. Alternatively, the image may be divided into any number of areas other than two or four, which means that the divisional areas may be a plurality of areas adjacent to each other, obtained by dividing the image into several areas. If 9 or more areas are obtained by dividing the image, however, it is less effective than in the case where two to four areas are obtained, because manipulation becomes difficult. Alternatively, instead of the divisional areas, the entire image may serve as one area. Alternatively, a part of the image may serve as an area for which the specific number is counted.

In addition, as a variation, video camera 102 may be implemented by a camera capable of picking up an infrared image. If a camera capable of picking up an infrared image is used, CPU 110 no longer needs to determine whether or not the color of the pixel is the flesh-color. This is because the camera capable of picking up an infrared image responds solely to the infrared ray emitted from a human body or other animals and because CPU 110 can use the signal output from that camera as it is to determine whether the hand or the like of user 101 covers a certain area. The equipment control apparatus according to the present embodiment may be implemented by a camera picking up an image of a human body by using static electricity, ultrasound or electromagnetic wave emitted from the human body, instead of video camera 102. A monochrome camera may be used only when difference in luminance between the hand or the like and the surroundings thereof can be detected.

In addition, as a variation, the recording medium from which reader 118 reads the program is not limited to the CD-ROM. Examples of the recording medium other than the CD-ROM include an FD (Flexible Disk), a flash memory, and a hard disk.

In addition, as a variation, the equipment control apparatus according to the present embodiment may be embedded in a wall of a building.

### Second Embodiment

An equipment control apparatus according to a second embodiment of the present invention will be described hereinafter.

The equipment control apparatus according to the present embodiment is the same as that in the first embodiment, and the function thereof is also the same. Therefore, detailed description thereof will not be repeated.

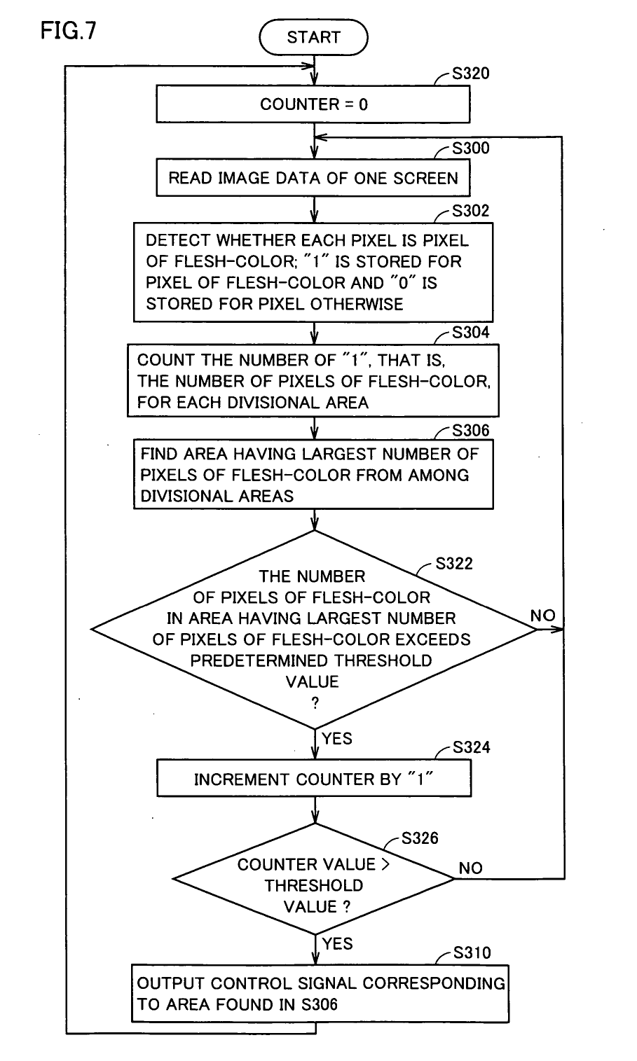

Referring to FIG. 7, the program executed in the equipment control apparatus carries out the following control for output of a control signal. It is noted that the processing in the flowchart in FIG. 7 that has been shown in FIG. 3 described previously is given the same step number, and the processing is also the same. Therefore, detailed description thereof will not be repeated.

In S320, CPU 110 sets the value of the counter to “0”.

In S322, CPU 110 determines whether the specific number of the area having the largest specific number exceeds a predetermined threshold value. If it is determined that the predetermined threshold value is exceeded (YES in S322), the process proceeds to S324. Otherwise (NO in S322), the process proceeds to S300. In S324, CPU 110 increments the value of the counter by “1”.

In S326, CPU 110 determines whether the value of the counter exceeds a prescribed threshold value. If it is determined that the value of the counter exceeds the prescribed threshold value (YES in S326), the process proceeds to S310. Otherwise (NO in S326), the process proceeds to S300.

An operation of the equipment control apparatus based on the configuration and the flowchart as above will now be described.

CPU 110 sets the value of the counter to “0” (S320). When the value of the counter is set to “0”, after the processing in S300 to S306, CPU 110 determines whether the specific number of the area having the largest specific number exceeds the predetermined threshold value (S322). Here, if it is assumed that the predetermined threshold value is exceeded (YES in S322), CPU 110 increments the value of the counter by “0” (S324). When the value of the counter is incremented by “1”, CPU 110 counts the excess number which indicates the number of times that the specific number exceeds the first threshold value. When the value of the counter is incremented, CPU 110 determines whether the value of the counter, that is, the excess number, exceeds the predetermined threshold value (S326). If it is assumed that the value of the counter initially does not exceed the threshold value (NO in S326), the processing in S300 to S326 is repeated. Thereafter, if the value of the counter exceeds the threshold value (YES in S326), terminal 116 outputs the control signal of a type corresponding to the divisional area (S310). Terminal 116 thus outputs the control signal of a type corresponding to the divisional area if the excess number is equal to or greater than the threshold value and if the specific number exceeds the threshold value.

As described above, the equipment control apparatus according to the present embodiment outputs the control signal if the user keeps holding his/her hand for a certain predetermined period or longer, not if the user momentarily holds his/her hand. Reliability of the equipment control apparatus is thus improved. Consequently, the equipment control apparatus readily made smaller in size, less likely to malfunction, and attaining high reliability can be provided.

Note that, as a variation, CPU 110 may determine in S326 whether the excess number is equal to or smaller than the predetermined threshold value. Here, terminal 116 may output the control signal of a type corresponding to the divisional area if the excess number is equal to or smaller than the threshold value and if the specific number exceeds the threshold value. Thus, if user 101 places his/her hand for too long a time period, the equipment control apparatus does not respond. Reliability of the equipment control apparatus is improved. Consequently, the equipment control apparatus readily made smaller in size, less likely to malfunction, and attaining high reliability can be provided.

In addition, as a variation, CPU 110 may determine in S326 whether the excess number is within a range from a certain threshold value to another threshold value. Here, terminal 116 may output the control signal of a type corresponding to the divisional area if the excess number is within that range and if the specific number exceeds the threshold value. Thus, unless a time period during which user 101 places his/her hand is within a certain range, for example, a range from 5 to 8 seconds, the equipment control apparatus does not respond. Reliability of the equipment control apparatus is improved. As to reliability in various applications, reliability in terms of security, for example, in a case of a key of a safe or an immobilizer of a vehicle, is particularly improved. Consequently, the equipment control apparatus readily made smaller in size, less likely to malfunction, and attaining high reliability in terms of security can be provided.

### Third Embodiment

An equipment control apparatus according to a third embodiment of the present invention will be described hereinafter.

The hardware configuration of the equipment control apparatus according to the present embodiment is the same as that in the first embodiment described previously, and the function thereof is also the same. Therefore, detailed description thereof will not be repeated.

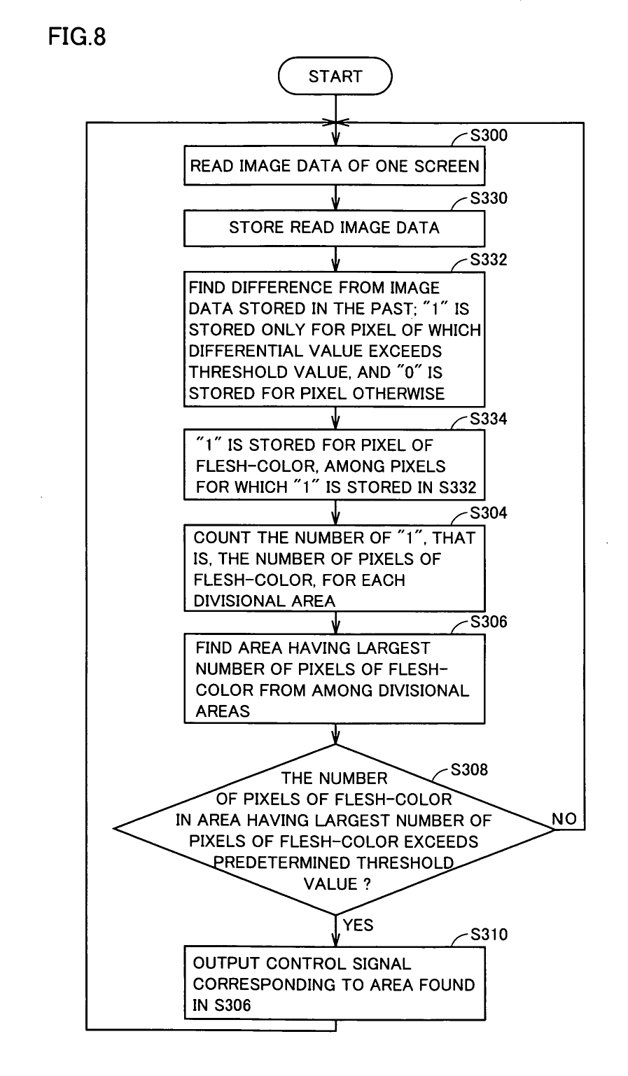

Referring to FIG. 8, the program executed in the equipment control apparatus carries out the following control for output of a control signal. It is noted that the processing in the flowchart in FIG. 8 that has been shown in FIG. 3 described previously is given the same step number, and the processing is also the same. Therefore, detailed description thereof will not be repeated.

In S330, CPU 110 causes memory 112 to store image data read from video camera 102, in a certain area thereof. By storing the image data, memory 112 stores a plurality of images. The plurality of images that are stored are images picked up by video camera 102, different in a time point of image pick-up.

In S332, CPU 110 finds a difference between image data stored in memory 112 in the past and image data stored in S330. Here, to “find a difference” refers to calculation of a difference between values representing the color of each pixel correspondingly arranged, among the pixels forming the image. CPU 110 thus calculates the value representing the difference in color, of the pixels at corresponding positions in a plurality of images. When the difference is found, CPU 110 determines whether a differential value which is a value representing the difference in color exceeds a certain threshold value. When determination as to whether or not the threshold value is exceeded is made, CPU 110 causes memory 112 to store the value corresponding to whether the differential value exceeds the threshold value. That value is stored in association with the pixel forming the most recent image, among the images stored in memory 112. In the present embodiment, “1” is associated with the pixel of which differential value exceeds the threshold value, and “0” is associated with the pixel of which differential value does not exceed the threshold value.

In S334, CPU 110 determines whether the color of the pixel associated with “1” in S332 is the color of skin of the human body. As described above, the pixel associated with “1” in S332 is the pixel of which differential value exceeds the threshold value. The pixel associated with “1” in S332 is also the pixel forming the most recent image among the images stored in memory 112. When determination as to whether the color of the pixel represents the color of skin of the human body is made, memory 112 stores a value separately from the value stored in S332. Among the values to be stored, the value “1” is associated with the pixel of the flesh-color.

An operation of the equipment control apparatus based on the configuration and the flowchart as above will now be described.

Memory 112 stores the image data picked up by video camera 102 (S330). When the image data is stored, CPU 110 finds the difference. When the difference is found, the value is stored in memory 112 based on whether the differential value exceeds the threshold value (S332). When the value is stored, CPU 110 causes memory 112 to store the value such that “1” is associated with the pixel of flesh-color, among the pixels for which “1” has been stored (S334).

As described above, the equipment control apparatus according to the present embodiment causes output of the control signal, as a result of such a movement as waving a hand in a certain divisional area instead of covering the same with hand. The control signal is thus output if a certain movement is detected. Consequently, the equipment control apparatus readily made smaller in size, less likely to malfunction, and capable of detecting a movement can be provided.

Note that, as a variation, CPU 110 may determine in S332 whether the differential value is equal to or smaller than a certain threshold value. Here, when determination as to whether the differential value is equal to or smaller than the threshold value is made, CPU 110 causes memory 112 to store the value corresponding to whether the differential value is equal to or smaller than the threshold value. The value is stored in association with the pixel forming the most recent image among the images stored in memory 112. In this case as well, “1” is associated with the pixel of which differential value exceeds the threshold value, and “0” is associated with the pixel of which differential value does not exceed the threshold value. Thus, CPU 10 determines in S334 whether the color of the pixel of which differential value is equal to or smaller than the threshold value represents the color of skin of the human body. When determination as to whether the color of the pixel of which differential value is equal to or smaller than the threshold value is the color of skin of the human body is made, the control signal is output if the hand stays in a certain divisional area, not if the hand is placed in that area merely for a short period of time.

### Fourth Embodiment

An equipment control apparatus according to a fourth embodiment of the present invention will be described hereinafter.

The hardware configuration of the equipment control apparatus according to the present embodiment is the same as that in the first embodiment described previously, and the function thereof is also the same. Therefore, detailed description thereof will not be repeated.

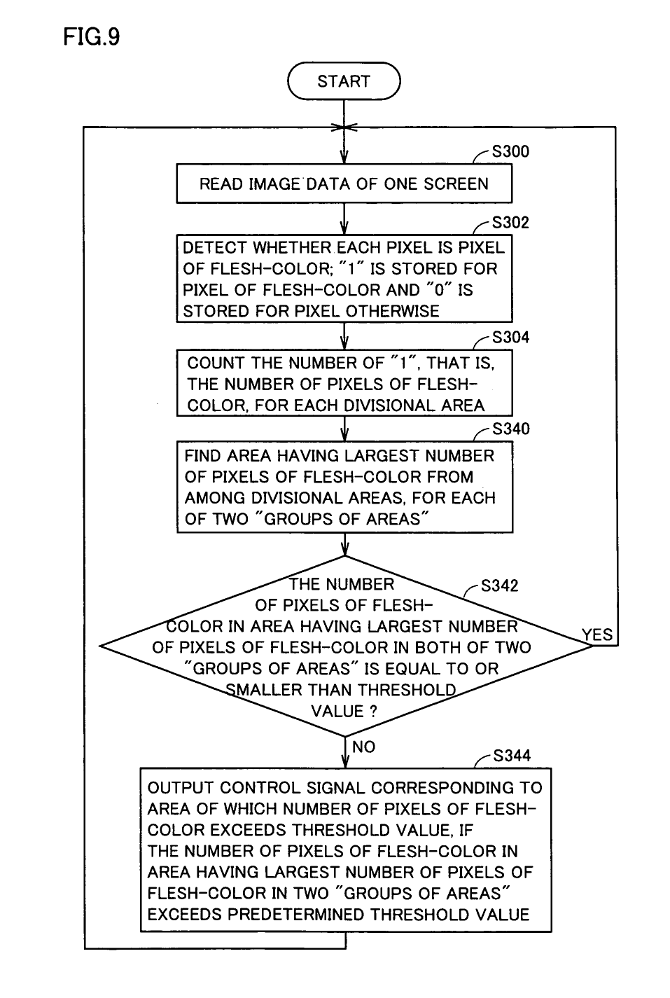

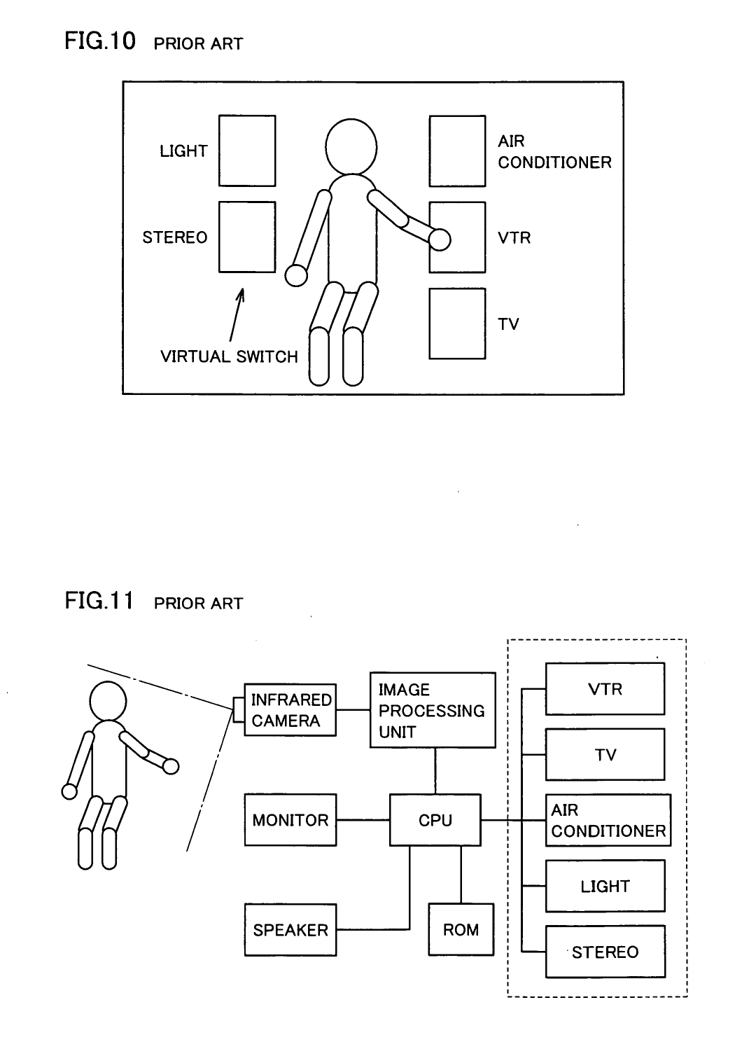

Referring to FIG. 9, the program executed in the equipment control apparatus carries out the following control for output of a control signal.

It is noted that the processing in the flowchart in FIG. 9 that has been shown in FIG. 3 described previously is given the same step number, and the processing is also the same. Therefore, detailed description thereof will not be repeated.

In S340, CPU 110 selects the area having the largest specific number among the divisional areas, for each of two “groups of areas.”

In S342, CPU 110 determines whether the specific number of the area having the largest specific number is equal to or smaller than a predetermined threshold value in both of the two “groups of the areas.” CPU 10 thus determines whether the specific number of the area having the largest specific number exceeds the threshold value for each group of the areas. If it is determined that the specific number is equal to or smaller than the predetermined threshold value (YES in S342), the process proceeds to S300. Otherwise (NO in S342), the process proceeds to S344.

In S344, terminal 116 outputs the control signal corresponding to the area of which specific number exceeds the threshold value in the two “groups of areas” if the specific number of the area having the largest specific number exceeds the predetermined threshold value. It is CPU 110 that generates the control signal to be output. Terminal 116 thus outputs the control signal of a type corresponding to each area of which specific number exceeds the threshold value.

An operation of the equipment control apparatus based on the configuration and the flowchart as above will now be described.

When the specific number is counted, CPU 110 selects the area having the largest specific number among the divisional areas, for each of the two “groups of areas.” In the present embodiment, it is assumed that first divisional area 201 and third divisional area 203 form one group, and second divisional area 202 and fourth divisional area 204 form one group. CPU 110 thus selects third divisional area 203, in the group consisting of first divisional area 201 and third divisional area 203. CPU 10 selects fourth divisional area 204, in the group consisting of second divisional area 202 and fourth divisional area 204 (S340). When the area is selected, CPU 110 determines whether the specific number of the area having the largest specific number is equal to or smaller than a predetermined threshold value TH in both of the two “groups of areas” (S342). Here, if it is assumed that the specific number of each of first divisional area 201 and fourth divisional area 204 exceeds predetermined threshold value TH (NO in S342), terminal 116 outputs the control signals corresponding to first divisional area 201 and fourth divisional area 204 respectively (S344).

As described above, the equipment control apparatus according to the present embodiment determines whether the user's hand or the like covers the area for each group of the areas, and outputs the control signal in accordance with the covered area if the user's hand or the like covers the area. A plurality of pieces of equipment can thus simultaneously operate. Consequently, the equipment control apparatus readily made smaller in size, less likely to malfunction, and capable of simultaneously performing a plurality of operations can be provided.

Note that, as a variation, in S344, terminal 116 may output the control signal corresponding to any area of which specific number exceeds the threshold value, in the two “groups of areas.” Terminal 116 thus outputs the control signal of a type corresponding to any area of which specific number exceeds the first threshold value.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An equipment control apparatus for controlling equipment, comprising:
an image pick-up unit picking up an image;
a storage unit storing image data representing the image picked up by said image pick-up unit and a program;
a processor, upon receiving an instruction from said program for,
(a) counting the number of pixels representing a color of skin of a human body among pixels in a part of said image to output the counted number as a specific number, based on said image data, and
(b) generating at least one control signal for controlling said equipment if the number exceeds a specific number threshold value; and
an output unit outputting said control signal.

2. The equipment control apparatus according to claim 1, wherein
a plurality of areas of said image correspond to different control signals, respectively,
said processor counts the number of pixels representing the color of skin in each of said areas, and selectively generates one of said control signals corresponding to the area where the counted number exceeds a corresponding specific number threshold value.

3. The equipment control apparatus according to claim 2, wherein
said processor generates said control signal of a type corresponding to each of said areas of which said specific number exceeds said specific number threshold value.

4. The equipment control apparatus according to claim 2, wherein
said processor counts said specific number for each of said plurality of areas obtained by dividing said image into two.

5. The equipment control apparatus according to claim 2, wherein
said processor counts said specific number for each of said plurality of areas adjacent to each other, obtained by dividing said image into four.

6. The equipment control apparatus according to claim 1, wherein
said storage unit stores said specific number in addition to said image data and said program, and
said processor, upon receiving the instruction from said program, further determines whether excess number that indicates number of times that said specific number exceeds said specific number threshold value exceeds an excess number threshold value representing a threshold value for said excess number, and generates said control signal if said excess number exceeds said excess number threshold value and if said specific number exceeds said specific number threshold value.

7. The equipment control apparatus according to claim 1, wherein
said storage unit stores said specific number in addition to said image data and said program, and
said processor, upon receiving the instruction from said program, further determines whether excess number that indicates number of times that said specific number exceeds said specific number threshold value is equal to or smaller than an excess number threshold value representing a threshold value for said excess number, and generates said control signal if said excess number is equal to or smaller than said excess number threshold value and if said specific number exceeds said specific number threshold value.

8. The equipment control apparatus according to claim 1, wherein
said storage unit stores said specific number in addition to said image data and said program, and
said processor, upon receiving the instruction from said program, further determines whether excess number that indicates number of times that said specific number exceeds said specific number threshold value is within a range defined by two threshold values for said excess number, and generates said control signal if said excess number is within said range defined by said two threshold values and if said specific number exceeds said specific number threshold value.

9. The equipment control apparatus according to claim 1, wherein
said image pick-up unit includes an image pick-up unit implemented as a color camera.

10. The equipment control apparatus according to claim 1, wherein
said image pick-up unit includes an image pick-up unit using a lens different from a wide-angle lens.

11. The equipment control apparatus according to claim 1, wherein
said image pick-up unit includes an image pick-up unit picking up an infrared image.

12. The equipment control apparatus according to claim 1, wherein
said processor counts said specific number for a plurality of said areas,
said storage unit stores, in addition to said image data and said program, said specific number for each of said plurality of areas, and
if a largest specific number out of said specific numbers stored in said storage unit exceeds said specific number threshold value, said processor generates said control signal of a type corresponding to said area having the largest specific number.

13. The equipment control apparatus according to claim 1, wherein
said processor counts said specific number for a plurality of said areas,
said storage unit stores, in addition to said image data and said program, said specific number for each of said plurality of areas in association with a group of said areas, and
if at least one of largest specific numbers in each said group of areas stored in said storage unit exceeds said specific number threshold value, said processor generates said control signal of a type corresponding to said area of which largest specific number exceeds said specific number threshold value.

14. The equipment control apparatus according to claim 1, wherein
said image data stored in said storage unit includes image data of a plurality of images picked up by said image pick-up unit, different in a time point of image pick-up,
said processor, upon receiving the instruction from said program, further calculates a value representing difference in color of the pixels at corresponding positions in said plurality of images, and determines whether said value representing difference in color exceeds a threshold value for said value representing difference in color,
said storage unit stores, in addition to said image data and said program, a value corresponding to whether said value representing difference in color exceeds said threshold value for said value representing difference in color, and
said specific number indicates the number of pixels corresponding to said value representing difference in color exceeding said threshold value for said value representing difference in color, and representing the color of skin of said human body among said pixels forming a most recent image among said plurality of images.

15. The equipment control apparatus according to claim 1, wherein
said image data stored in said storage unit includes image data of a plurality of images picked up by said image pick-up unit, different in a time point of image pick-up,
said processor, upon receiving the instruction from said program, further calculates a value representing difference in color of the pixels at corresponding positions in said plurality of images, and further determines whether said value representing difference in color is equal to or smaller than a threshold value for said value representing difference in color,
said storage unit stores, in addition to said image data and said program, a value corresponding to whether said value representing difference in color is equal to or smaller than said threshold value for said value representing difference in color, and
said specific number indicates the number of pixels corresponding to said value representing difference in color equal to or smaller than said threshold value for said value representing difference in color, and representing the color of skin of said human body among said pixels forming a most recent image among said plurality of images.

16. The equipment control apparatus according to claim 1, further comprising a housing.

17. A remote controller for controlling equipment, comprising:
an image pick-up unit picking up an image;
a storage unit storing image data representing an image picked up by said image pick-up unit, a program, and information for controlling said equipment;
a processor, upon receiving an instruction from said program,
(a) counting specific number that indicates number of pixels representing a color of skin of a human body among pixels forming said image, for an area representing at least a part of said image, based on said image data, and
(b) generating a control signal for controlling said equipment based on said information for controlling said equipment if said specific number exceeds a specific number threshold value representing a threshold value for said specific number; and
a transmission device transmitting said control signal.

18. Equipment, comprising:
an image pick-up unit picking up an image;
a storage unit storing image data representing an image picked up by said image pick-up unit and a program;
a processor, upon receiving an instruction from said program,
(a) counting specific number that indicates number of pixels representing a color of skin of a human body among pixels forming said image, for an area representing at least a part of said image, based on said image data, and
(b) generating a control signal if said specific number exceeds a specific number threshold value representing a threshold value for said specific number; and
a device operating in response to said control signal.

19. An equipment control method for controlling equipment, comprising:
image pick-up step of picking up an image;
the step of determining whether a color of a pixel forming the image picked up in said image pick-up step is color of skin of a human body;
the step of counting specific number that indicates number of pixels representing the color of skin of the human body among pixels forming said image, for an area representing at least a part of said image; and
the step of outputting a control signal for controlling said equipment if said specific number exceeds a specific number threshold value representing a threshold value for said specific number.

20. An equipment control program product for controlling equipment, causing a computer to execute the steps of:
controlling an image pick-up unit so as to pick up an image;
determining whether a color of a pixel forming the image picked up in said controlling step is color of skin of a human body;
counting specific number that indicates number of pixels having the color of skin of the human body among pixels forming said image, for an area representing at least a part of said image; and
outputting a control signal for controlling said equipment if said specific number exceeds a specific number threshold value representing a threshold value for said specific number.
